(19) United States
(12) Patent Application Publication
(10) Pub. No.: US 2019/0263456 A1
(43) Pub. Date: Aug. 29, 2019

(54) CROSS WIND STABILIZER FOR AERODYNAMIC FAIRING ASSEMBLY

(71) Applicant: Wall Global, LLC., Franklin, TN (US)

(72) Inventors: Billy Russell Wall, II, Franklin, TN (US); Terry L. Lampley, Chapel Hill, TN (US)

(21) Appl. No.: 15/904,046

(22) Filed: Feb. 23, 2018

(51) Int. Cl. B62D 35/00

(52) U.S. Cl. CPC B62D 35/001

(57) ABSTRACT

The cross wind stabilizer of this invention supports and reinforces retractable side fairings deployed from tractors to enclose or partially enclose the gaps between the tractor cab and trailer. The cross wind stabilizer uses one or more adjustable struts that deploy with the retractable side fairings from a stowed position to an operational position. In one exemplary embodiment, the stabilizer includes a main strut, secondary strut, and two sets of paired guide cables. The stabilizer is mounted directly to the aerodynamic fairing assembly and is suspended between the inflatable panels and the assemblies support framework. The stabilizer moves between an extended operational position and a collapsed stowed position in conjunction with the deployment of the inflatable panels. The struts work in conjunction with guide cables to support and reinforce the inflatable panels against cross winds.

This invention relates to an aerodynamic fairing assembly for tractor-trailers, and particularly, a structure for stabilizing retractable fairing panels deployed behind the cab of tractor-trailer moving through cross winds.

### BACKGROUND OF THE INVENTION

Aerodynamic drag is a major contributor to fuel consumption in tractor-trailer commerce. Aerodynamic improvements can contribute to fuel savings and provide significant cost reduction. Air foils and aerodynamic fairings are mounted to tractor-trailers to provide a degree of aerodynamic improvement.

The gaps between the tractor trucks and trailers are necessary for the articulation of the tractor-trailer; however, the gaps between tractor trucks and trailers are a particular source for aerodynamic drag. A variety of retractable aerodynamic fairing systems have been developed, which deploy to cover or enclose the gaps between tractor trucks and connected trailers. Rigid panel fairing systems use a variety of mechanical arms, linkages, tracks, slides, motors and actuators to manually or automatically move large rigid fairing panels between stowed and deployed positions enclosing the gaps. Other systems, such as the inflatable fairing systems described in U.S. Pat. No. 9,873,467 and available from Wall Global, in Franklin, Tenn., use inflatable panels deployed from panel housings to enclose the gaps between the tractor truck and trailer.

Cross winds present additional aerodynamic problems for tractor-trailers and aerodynamic fairing systems. Cross winds can exert significant loads on the fairing panels, which can contort, deflect and damage the panels and any deployment mechanisms. This is particularly true for retractable fairing systems that deploy to enclose the gaps between the tractor and connected trailers.

### SUMMARY OF THE INVENTION

The cross wind stabilizer of this invention supports and reinforces retractable side fairings deployed from tractors to enclose or partially enclose the gaps between the tractor cab and trailer. The cross wind stabilizer uses one or more adjustable struts that deploy with the retractable side fairings from a stowed position to an operational position. In one exemplary embodiment, the stabilizer includes a main strut, secondary strut, and two sets of paired guide cables. The stabilizer is mounted directly to the aerodynamic fairing assemble and is suspended between the inflatable panels and the assemblies support framework. The stabilizer moves between an extended operational position and a collapsed stowed position in conjunction with the deployment of the inflatable panels. The struts work in conjunction with guide cables to support and reinforce the inflatable panels against cross winds.

The cross wind stabilizer of this invention can be adapted for use with retractable rigid fairing panels, but is specifically designed for use with the inflatable fairing panels of the type used on the retractable fairing assemblies available from Wall Global, LLC. of Franklin, Tenn. The stabilizer deploys with the inflating side panels and braces the inflated panels against cross winds that may contort or displace the panels when deployed. In addition, the configuration of the struts ensures that the stabilizer will not interfere with any refrigeration units or other structures mounted to the front wall of a connected trailer.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a perspective view of an exemplary embodiment of the cross wind stabilizer of this invention shown in use with the deployed inflatable side panels of a conventional retractable aerodynamic fairing assembly;

FIG. 2 is partial perspective view of the stabilizer and inflatable side panel of FIG. 1;

FIG. 3 is side sectional view of the stabilizer and fairing assembly of FIG. 1 in the extended operational position;

FIG. 4 is a top view of the stabilizer and fairing assembly of FIG. 1 in the extended operational position; and

FIG. 5 is a top view of the stabilizer and fairing assembly of FIG. 1 in the collapsed stowed position.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

The cross wind stabilizer of this invention is designed to be incorporated into the retractable aerodynamic fairing assemblies of tractor-trailers. While acting as sturdy, light-weight side fairings that enclose or cover the space between the tractor truck and trailer, retractable side fairings can contort and deflect as the tractor-trailer moves through cross winds. The cross wind stabilizer supports and reinforces retractable side fairings deployed from tractors to enclose or partially enclose the gaps between the tractor cab and trailer. The cross wind stabilizer of this invention can be adapted for use with retractable rigid fairing panels, but is specifically designed for use with the inflatable fairing panels of the type used on the retractable fairing assemblies manufactured and sold by Wall Global, LLC. of Franklin, Tenn. The cross wind stabilizer of this invention includes one or more adjustable struts that deploy with the retractable side fairings from a stowed position to an operational position. The struts support and reinforce the retractable side fairings and prevent the fairings from contorting and deflecting as the tractor-trailer moves through cross winds.

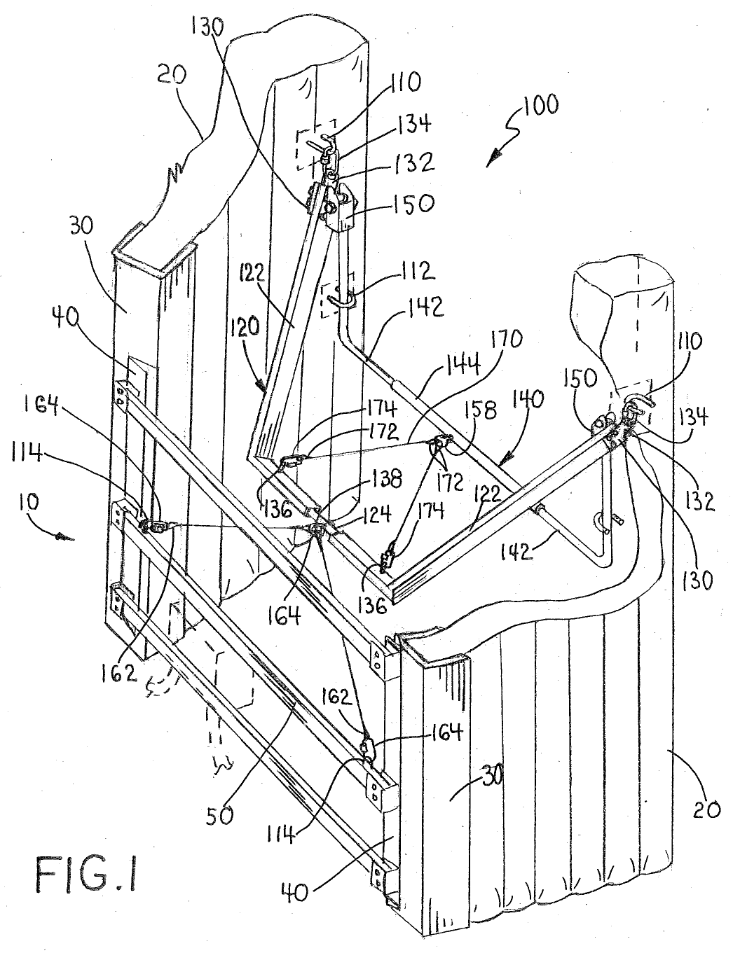

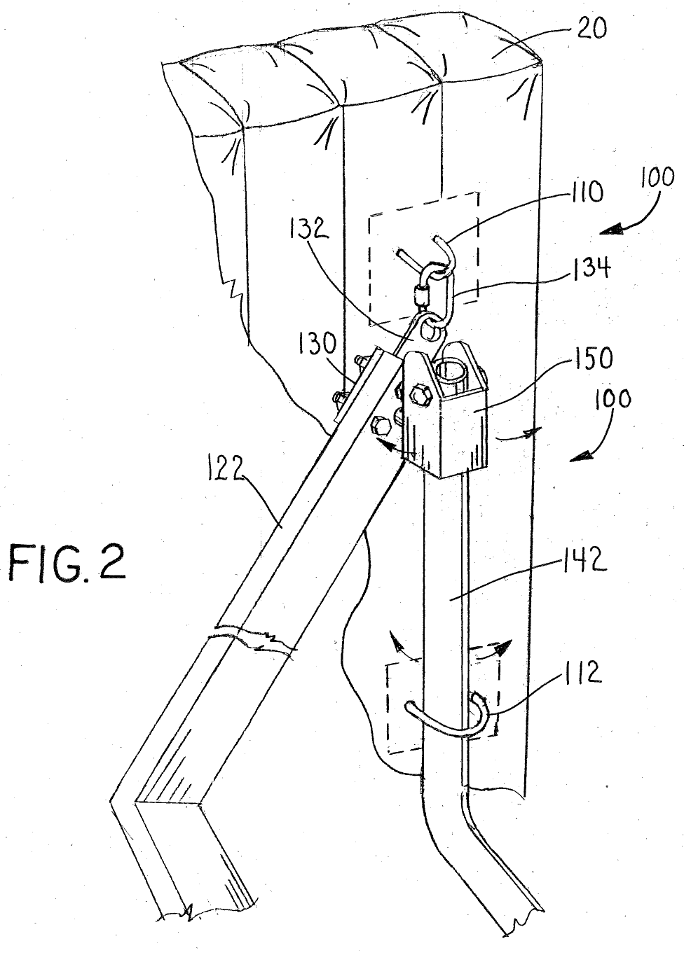

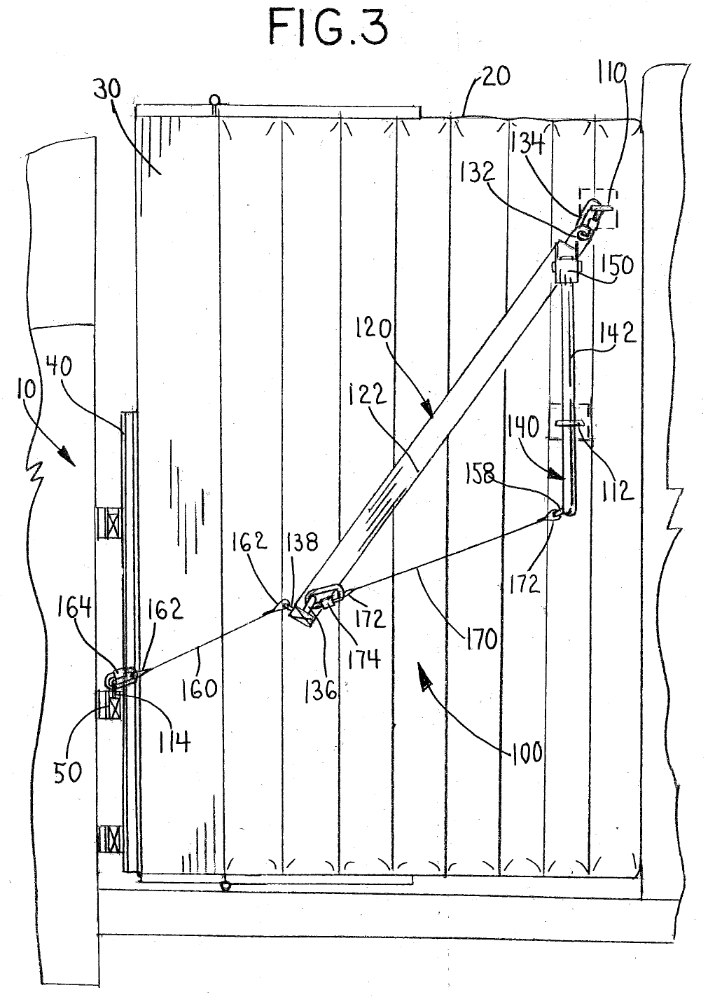

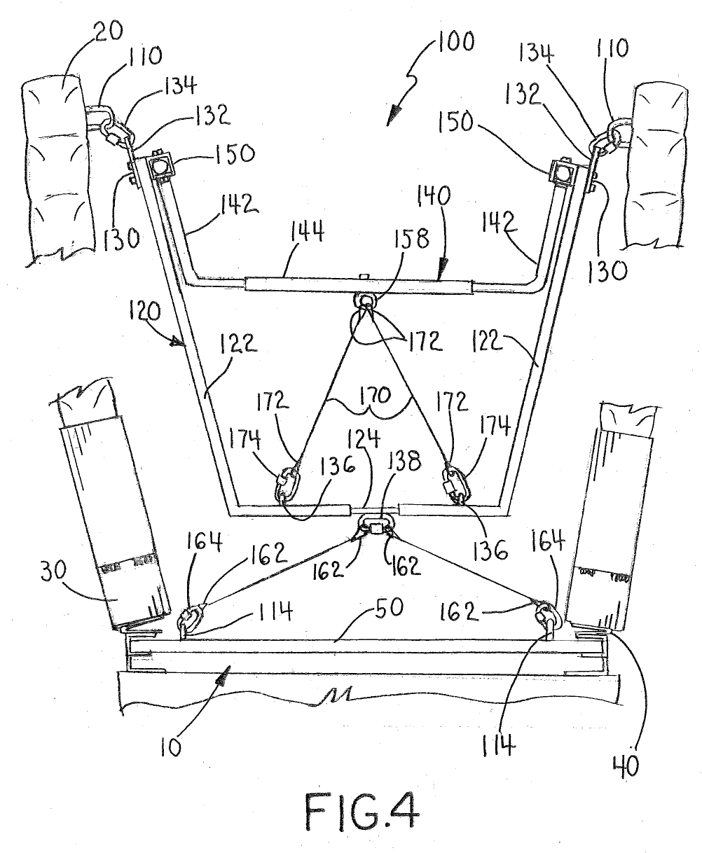

Referring now to the drawings, FIGS. 1-5 illustrate an exemplary embodiment of the cross wind stabilizer of this invention, which is designated generally as reference numeral 100. Stabilizer 100 is illustrated as part of an aerodynamic fairing assembly 10. Fairing assembly 10 is of the type manufactured and sold by Wall Global, LLC. of Franklin, Tenn. As shown, fairing assembly 10 is mounted behind the cabs of tractor truck (not shown) and deploys a pair of inflatable wall panels 20 from panel housings 30 to act as side fairings covering and enclosing the gap between the tractor (not shown) and the front of the connected semi-trailer (not shown). A support framework affixes panel housings 30 to the back wall of the tractor cab and includes a pair of frame uprights 40 and three cross braces 50.

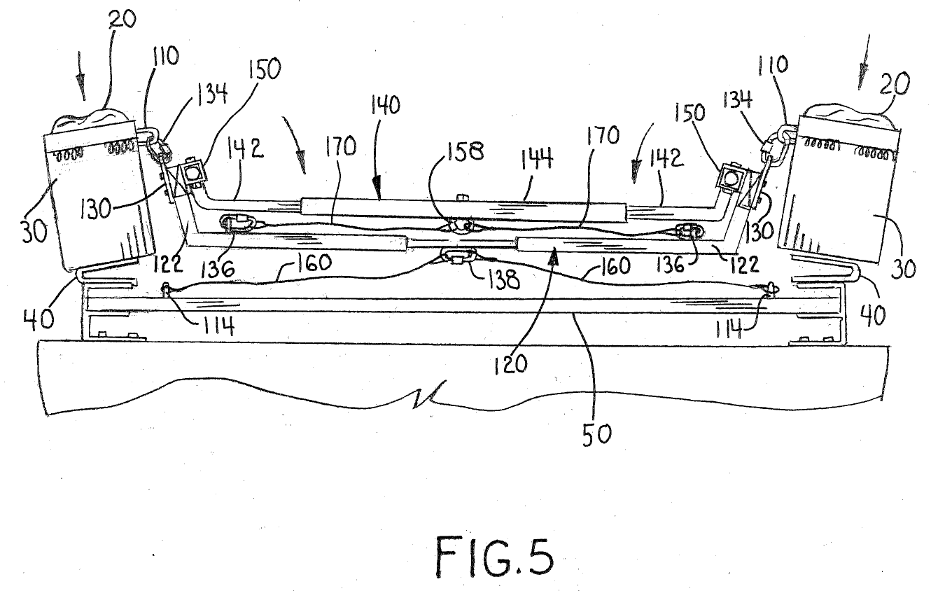

Stabilizer 100 includes a main strut 120 and secondary strut 140 and two sets of paired guide cables 160 and 170. Stabilizer 100 is mounted directly to the fairing assembly 10 suspended between inflatable panels 20 and affixed to the support framework. Stabilizer 100 moves between an extended operational position (FIG. 1-4) and a collapsed stowed position (FIG. 5) in conjunction with the deployment of the inflatable panels. Struts 120 and 140 work in conjunction with guide cables 160 and 170 to brace inflatable panels 20 against cross winds. Struts 120 and 140 provide the structural component of stabilizer 100 that resists the lateral compression of inflatable panels 20 when deployed. Paired guide cables 160 and 170 provide the structural component of stabilizer 100 that resists lateral tension on the inflatable panels 20 when deployed.

Main strut 120 includes a pair of “hockey-stick” shaped arms 122 shiftably joined at opposed ends by a cross member 124. The “hockey-stick” shaped arms 122 gives main strut 120 a truncated “V-shape” configuration. Arms 122 and cross member 124 are constructed of a metal tubing, such as aluminum or steel. Ideally, a rectangular metal tubing is used for main strut 120 to provide sufficient strength and rigidity to brace inflatable panels 20. The opposed ends of arms 122 slide over cross member 124 and are secured in place by fasteners, bolts and nuts (not shown), which allows the length of strut 120 to be selectively set accommodating the varying fairing assembly widths. The distal end of each arm 122 is connected to the inward facing sidewall of the adjacent inflatable panel 20. Each inflatable panel 20 has a D-ring 110 mounted to its inward facing sidewall. A mounting plate 130 having an eyelet 132 is affixed to the distal ends of each arm 122. Snap links 134 coupled to the eyelet 132 and D-ring 110 connect strut 120 to panel 20.

Similarly, secondary strut 140 includes a pair of L-shaped arms 142 shiftably joined at opposed ends by a cross member 144. The L-shaped arms 142 give main strut 120 a truncated “U-shape” configuration. Arms 142 and cross member 144 are again constructed of a metal tubing, such as aluminum or steel, but round tubing is generally sufficient for the secondary strut. As with strut 120, the opposed ends of arms 142 slide over cross member 144 and are secured in place by fasteners, bolts and nuts (not shown), which allows the length of strut 124 to be selectively set accommodating the varying fairing assemble widths. The distal end of each arm 142 is pivotally connected to the distal end of arms 122 by mounting brackets 150 so that secondary strut 140 hangs freely from main strut 120. Each mounting bracket 150 is pivotally mounted directly to arm 122 by fasteners, generally bolts, washers and hex nuts (not shown but well understood). Arms 142 are pivotally connected within brackets 150 also by a bolt and hex nut that extends through aligned bores in the brackets and arms. Each arms 142 also extend freely through a second D-ring affixed to the inner sidewall of the adjacent inflatable panel 20.

Ideally, guide cables 160 and 170 are braided wire cables with looped thimble ends 162 and 172 respectively. The use of braided wire in paired guide cables 160 and 170, rather than rigid rods or beams, which may be used in alternative embodiments, helps prevent mechanical failures due to ice and debris fouling. Snap links 164 connect one end of each cable 160 to a central eyelet 138 welded or otherwise connected to cross member 124 and the other end of each cable to spaced D-rings 114 mounted to one of the cross braces 150 of the fairing assemblies' support framework. Snap links 174 connect one end of each cable 170 to a central eyelet 158 welded or otherwise affixed to cross member 124 and the other end of each cable to spaced D-rings 114 welded or otherwise mounted to each arm 122 of main strut 120.

FIG. 5 shows stabilizer 100 and fairing assembly 10 in a collapsed stowed position. In the collapsed stowed position, struts 120 and 140 are folded together adjacent the cross braces 50 of the fairing assemblies' support framework. FIGS. 1-4 show stabilizer 100 and fairing assembly 10 in an extended operational position. In the extended operational position, the truncated V-shape of main strut 120 and U-shape of secondary strut 140 prevents any interference between stabilizer 100 and any refrigeration units or other structures mounted to the front wall of a connected trailer. As inflatable panels 20 deploy from panel housings 30, the inflating panels pull main strut 120 rearward tethered by guide cables 160. Once inflatable panels 20 are fully inflated, main strut 120 held by guide cables 160 is suspended at an angle between the fully deployed inflatable panels 20. In the extended operational position, secondary strut 140 hangs vertically between the deployed inflatable panels 20. Arms 142 hang vertically to brace the inflatable panels along their vertical length near the distal end of the panels. D-ring 112 helps hold secondary strut 140 in position vertically adjacent inflatable panels 20. In the extended operational position, the paired cables 160 and 170 and struts 120 and 140 prevent any lateral movement (“sway”) in both stabilizer 100 and deployed inflatable panels 20. As inflatable panels 20 deflate and retract back into panel housing 20, stabilizer 100 is pulled back to its collapsed stowed position. As the stabilizer 100 is retracted back to the collapsed stowed position, arms 142 are free to slide and shift within D-rings 112 on inflatable panels 20.

As shown, stabilizer 100 uses a dual strut design where two separate strut components held by separate guide cables extend to brace the inflatable side panels. In other embodiments of this invention, the stabilizer may use a single main strut component. In still other embodiments, the stabilizer may use a single main strut in combination with only the hanging vertical arms of the secondary strut, as above, without the connecting cross member. In such an embodiment, the hanging vertical arms provide vertical bracing along the vertical length of the inflatable panels.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. An apparatus for use in an aerodynamic fairing assembly mounted to a tractor including a support framework and a pair of retractable side fairing panels that move between a first position retracted against the tractor and a second position extended from the tractor, the apparatus comprising:
a strut connected to and suspended between the pair of retractable side fairing panels; and
a pair of guide cables connected to and suspended between the support framework and the strut,
the strut includes a pair of elongated strut arms connected to a strut cross member, each of the pair of strut arms having one arm end thereof connected to one of the pair of retractable side fairing panels and the other arm end thereof connected to the strut cross member,
each of the pair of guide cables having one cable end thereof connected to the strut cross member and the other cable end thereof connected to the support framework.

2. The Apparatus of claim 1 wherein the pair of strut arms are adjustably connected to the strut cross member to selectively set the length of the strut.

3. The apparatus of claim 1 wherein each of the pair of strut arms are hockey-stick shaped having a first section and a second section shorter than the first section, the second section of each pair of strut arms is connected to the strut cross member and the first section of each pair of strut arms is pivotally connected to one of the pair of retractable side fairing panels.

4. The apparatus of claim 1 wherein the other cable end of each pair of guide wires is connected to the support framework at laterally spaced locations on the support framework.

5. The apparatus of claim 1 and also comprising;
a second strut connected to and suspended from the first strut; and
a second pair of guide cables connected to and suspended from the first strut,
the second strut includes a pair of elongated second strut arms connected to a second strut cross member, each of the pair of second strut arms having one arm end thereof connected to one of the first strut arms and the other arm end thereof connected to the second strut cross member,
each of the second pair of guide cables having one cable end thereof connected to the second strut cross member and the other cable end thereof connected to the first strut.

6. The apparatus of claim 5 wherein the second pair of strut arms are adjustably connected to the second strut cross member to selectively set the length of the second strut.

7. The apparatus of claim 5 wherein each of the pair of second strut arms are L-shaped having a first section thereof and a second section thereof shorter than the first section, the second section of each of the pair of second strut arms is connected to the second strut cross member and the first section of each pair of second strut arms is pivotally connected to one of the pair of first strut arms.

8. The apparatus of claim 7 wherein the first section of each pair of second strut arms lies longitudinally adjacent the one of the pair of retractable side fairing panels.

9. The apparatus of claim 5 wherein the other cable end of each pair of second guide wires is connected to the first strut at laterally spaced locations on the first strut.

10. The apparatus of claim 1 wherein the strut also includes a pair of elongated second strut arms, each of the pair of second strut arms pivotally connected to and suspended from one of the pair of first strut arms, each of the pair of second strut arms lies longitudinally adjacent the one of the pair of retractable side fairing panels.

11. An apparatus for use in an aerodynamic fairing assembly mounted to a tractor
including a support framework and a pair of retractable side fairing panels that move between a first position retracted against the tractor and a second position extended from the tractor, the apparatus comprising:
a first strut connected to and suspended between the pair of retractable side fairing panels;
a second strut connected to and suspended from the first strut;
a pair of first guide cables connected to and suspended between the support framework and the strut, and
a second pair of guide cables connected to and suspended from the first strut,
the first strut includes a pair of elongated first strut arms connected to a first strut cross member, each of the pair of first strut arms having one arm end thereof connected to one of the pair of retractable side fairing panels and the other arm end thereof connected the first strut cross member, the pair of first strut arms are adjustably connected to the strut cross member to selectively set the length of the first strut, each of the pair of first strut arms are hockey-stick shaped having a first section and a second section shorter than the first section, the second section of each pair of first strut arms is connected to the first strut cross member and the first section of each pair of first strut arms is pivotally connected to one of the pair of retractable side fairing panels,
the second strut includes a pair of elongated second strut arms connected to a second strut cross member, each of the pair of second strut arms having one arm end thereof connected to one of the first strut arms and the other arm end thereof connected the second strut cross member, the second pair of strut arms are adjustably connected to the second strut cross member to selectively set the length of the second strut, each of the pair of second strut arms are L-shaped having a first section thereof and a second section thereof shorter than the first section, the second section of each of the pair of second strut arms is connected to the second strut cross member and the first section of each pair of second strut arms is pivotally connected to one of the pair of first strut arms, the first section of each pair of second strut arms lies longitudinally adjacent the one of the pair of retractable side fairing panels,
each of the pair of first guide cables having one cable end thereof connected to the strut cross member and the other cable end thereof connected to the support framework, the other cable end of each pair of first guide wires is connected to the support framework at laterally spaced locations on the support framework,
each of the pair of second guide cables having one cable end thereof connected to the second strut cross member and the other cable end thereof connected to the first strut, the other cable end of each pair of second guide wires is connected to the first strut at laterally spaced locations on the first strut.
